(19) United States
(12) Patent Application Publication
(10) Pub. No.: US 2006/0254958 A1
(43) Pub. Date: Nov. 16, 2006

(54) Method for manufacturing integrated circuits

(76) Inventors: Peter Brandl, Villach (AT); Klaus Locke, Wernau (DE); Johann Tolonics, Heilbronn (DE)

Correspondence Address: MCGRATH, GEISSLER, OLDS & RICHARDSON, PLLC, P.O. BOX 1364, FAIRFAX, VA, 22038-1364, US

(21) Appl. No.: 11/432,403

(22) Filed: May 12, 2006

(30) Foreign Application Priority Data
May 12, 2005 (DE) DE102005021932

(51) Int. Cl. B03B 7/00

(52) U.S. Cl. 209/17

(57) ABSTRACT

A method for manufacturing integrated circuits with silicon-germanium heterobipolar transistors is provided, wherein the manufacturing process is divided into several process modules, whereby at least one collector module for the production of a collector region, one base module for the production of a base region, and one emitter module for the production of an emitter region are defined as process modules and whereby the process modules have such process interfaces relative to each other, that to develop a technology version different from the existing technology version at least one process step of a process module is changed independent of the process steps of the other process modules while the process interface is maintained.

This nonprovisional application claims priority under 35 U.S.C. § 119(a) on German Patent Application No. DE102005021932, which was filed in Germany on May 12, 2005, and which is herein incorporated by reference.

### BACKGROUND OF THE INVENTION

1. Field of the Invention

The present invention relates to a method for manufacturing integrated circuits.

2. Description of the Background Art

Integrated semiconductor circuits and methods for manufacturing the same, which have heterobipolar transistors with a silicon-germanium mixed crystal in the base semiconductor region, are known from the conventional art.

### SUMMARY OF THE INVENTION

It is an object of the present invention to provide a method for manufacturing integrated circuits.

Accordingly, a method is provided for manufacturing integrated circuits with silicon-germanium heterobipolar transistors. The manufacturing process is divided into several process modules. A process module hereby, however, preferably has at least two process steps of the manufacturing process. For the division, according to the invention, several or all process steps can be combined into modules.

Process modules can be: a collector module for the production of a collector region; a base module for the production of a base region; or an emitter module for the production of an emitter region.

The collector region, the base region, and the emitter region thereby have areas of active semiconductor regions. The active semiconductor regions can be at least partially single-crystal. The active semiconductor region of the base can be directly adjacent to the active collector region and/or the active emitter region, which is formed as a single crystal at least at the interface. In this regard, in the manufacturing process additional thin intrinsic layers can be provided, which, for example, can be doped during the further course of the process by diffusion of dopants as the base region, as the collector region, or as the emitter region.

Essential to the invention, thereby, is the development of a technology version, which is different from the existing technology version, in that the process modules can have such process interfaces relative to one another that at least one process step of a process module can be changed independent of the process steps of the other process modules for the different technology version while the process interface is maintained.

In addition to the above described modules, a connection module can be provided to produce an buried connecting region. Also, in a further embodiment of the invention, the collector region or the emitter region can be adjacent to the connecting region. A buried connecting region is understood to be a conductive region for connecting a semiconducting, preferably active region, which relative to the wafer surface is placed preferably at least partially below an active semiconductor region, for example, a heterobipolar transistor.

A further embodiment of the invention provides that one or more base module process steps, which determine an extrinsic base thickness and/or an extrinsic base dopant concentration in an area of the extrinsic base region independent of one or more emitter module process steps, which determine an emitter thickness and/or an emitter dopant concentration in an active area of the emitter region, can be changed to develop the different technology version. Here, preferably in combination the parameters of the intrinsic base independent of the parameters of the emitter region are also formed, so that the process interface defines no restrictions at least in regard to thicknesses and dopant concentrations.

In another embodiment of the invention, a process interface can be placed between the base module and emitter module in a sequence of process steps after application of a silicon-germanium semiconductor layer of the base module and, moreover, before the application of a silicon layer of the base module. The process interface is, for example, placed at a process time between two process steps, particularly defined in the process interface, and contains, for example, dopant concentrations and process time periods for the subsequent or preceding processes.

The process interface, however, can be placed for two different process times and for these two process times has parameters, such as, for example, dopant concentrations, temperatures, or process time periods of one process or several processes. The first process time as part of the process interface can be placed after the application of the silicon-germanium semiconductor layer. The second process time, as part of the process interface, can be placed before the application of the silicon layer of the base module.

The silicon layer of the base module can be deposited selectively on dielectric regions, at least above the silicon-germanium semiconductor layer. A layer of the emitter module can be placed between the silicon-germanium layer and the silicon layer of the base module. The silicon layer of the base module can be applied thereby polycrystalline at least in areas. This deposition of the silicon layer of the base module therefore occurs self-aligning due to the previously already applied dielectric regions and the selective deposition of the silicon layer.

The silicon layer of the base module is thereby preferably suitable for low-ohmic connection of the silicon-germanium semiconductor layer. To this end, the silicon layer has, for example, an especially high dopant concentration, so that the silicon layer also functions as a diffusion source and dopes at least one layer between the silicon layer and the silicon-germanium semiconductor layer preferably in a high-temperature process step. The doping occurs thereby in such a way that this at least one intermediate layer after the doping has substantially the same conductivity type as the silicon-germanium semiconductor layer.

A further embodiment provides that one or more process steps of the emitter module occur in time between at least two process steps of the base module. In addition or alternatively, it is possible that one or more process steps of the base module occur in time between at least two process steps of the emitter module. This interlacing thereby can be used for all process modules with a process interface in each case to another process module. Therefore, not every process interface is related absolutely solely to one point in time.

Yet another further embodiment of the invention provides that to develop a new technology generation, different from the existing technology generation, at least one process interface condition of at least one of the process interfaces is changed. In this case, the result of this modification is that versioning no longer occurs. A compatibility of the technology versions among one another, which is made possible by versioning, is thereby relinquished to enable more significant adjustments of the overall manufacturing process to new requirements for electrical properties with additional degrees of freedom. In order to simplify the testing of the new technology generation as much as possible, it can be provided that at most three process interface conditions of the process interfaces are changed.

A process interface condition thereby can be, for example, any process parameter or any combination of several process parameters, which has consequences for further processes of at least one other module, so that these would also need to be adjusted during a change in this process interface condition.

The process interfaces can have one or more process conditions, which relate to processes of at least two modules. For example, a high-temperature epitaxy process step in the collector module or emitter module relates to both the diffusion and thereby the dopant distribution of the dopants, introduced in the connection module, and also to the diffusion and thereby the dopant distribution of the dopants, introduced in the collector module or emitter module, the dopants diffusing during the high-temperature epitaxy process step.

Another embodiment of the invention therefore provides that a process interface condition can have a thickness range between a minimal thickness and a maximum thickness of a silicon layer applied in the emitter module. An area of this silicon layer is redoped by process steps of the base module, to assure a low-ohmic connection of a silicon-germanium semiconductor layer previously applied in the base module.

Further, within the base module, a semiconductor layer is applied, which thereby is doped in situ with dopants of the conductivity type of the base region. The active base region thereby has the silicon-germanium semiconductor layer. Also, at least one single-crystal region and one polycrystalline region of this semiconductor layer can be formed with the epitaxial application depending on the substrate.

Technology versions differ when the electrical properties of at least one integrated component change with the change in technology. Preferably, the heterobipolar transistor is adapted to the desired specifications with the new technology version.

The production of the highly doped, metallic, and/or silicided leads for the aforementioned active regions can thereby be a component of the specific process module and/or form one or more separate process modules.

According to another embodiment, at least one process module can have at least two module variants. The module variants thereby are used in one and the same technology version to produce different components with a reduced number of necessary process steps. The at least two module variants can be carried out in the same integrated circuit. For example, base connections with different base series resistors can be realized by different dopant concentrations, or a first module variant can be designed to produce a collector region and a second module variant for at least partial parallel production of an emitter region.

In another embodiment of the invention, it is provided that at least one of the process interfaces can have at least one process interface condition, which is dependent on at least two process parameters in combination, variable within specified regions. Their variability is thereby preferably limited by the process interface condition or by other process conditions. Process parameters can thereby be all manufacturing process parameters adjustable within one or more process steps, such as, for example, an implantation dose, implantation energy, the duration of the tempering step, or the duration of an etching.

The process interface condition makes it possible to thereby change the process parameters for the different technology version, whereby the process parameters in combination, however, must continue to fulfill the process interface condition. The combination of the process parameters can be established, for example, by an algorithm, and in the simplest cases by a summation or multiplication. Preferably, thereby the process interface condition is multidimensional. Advantageously, the process interface condition, by suitable degrees of freedom in the variability of the process parameters, enables a flexibility in the design of the different technology version. For example, the process interface condition is a diffusion length, which depends on a dopant, a dopant concentration, and a thermal budget of subsequent process modules as variable process parameters. Accordingly, with maintenance of the condition of the diffusion length, both the dopant, the dopant concentration, and also the thermal budget can be changed in combination and hereby the technology can be versioned.

Another embodiment provides for semiconductor circuits that have different technology versions, which have silicon-germanium heterobipolar transistors with several different structural modules, and which were produced by the previously described method.

Also, the invention provides for a use of the previously described method for manufacturing integrated circuits or previously described semiconductor circuits to adapt the technology version to application-specific boundary conditions.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates process modules with assigned process interfaces; and

FIG. 2 is a schematic sectional view according to the process steps of the manufacture of an integrated circuit.

### DETAILED DESCRIPTION

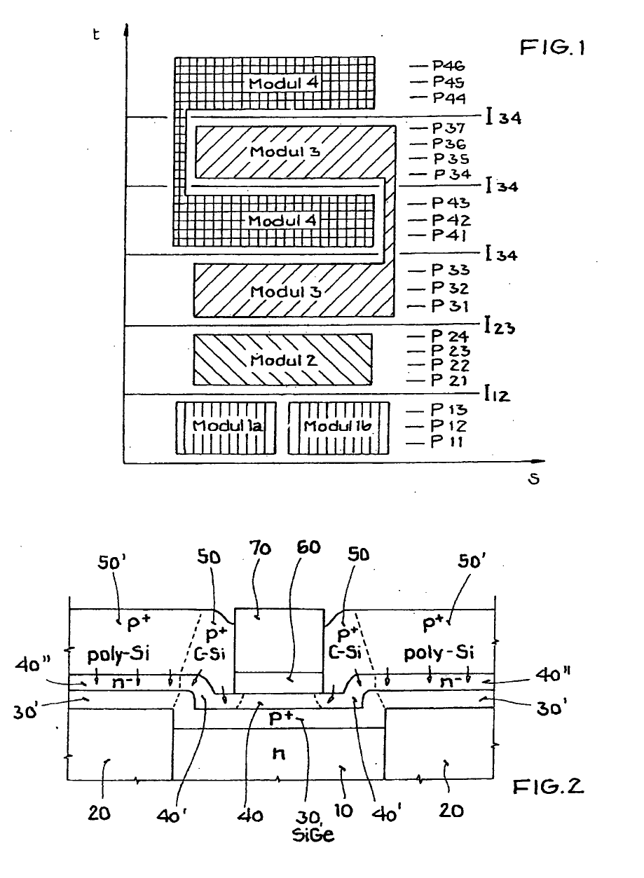

According to FIG. 1, a manufacturing process for an integrated circuit with a silicon-germanium heterobipolar transistor is divided into several process modules-module 1a, module 1b, module 2, module 3, and module 4. Thereby, the module division of the exemplary embodiment of FIG. 1 shows a first module variant, module 1a, and a second module variant, module 1b, for the first module (module 1a/module 1b).

FIG. 1 shows by way of example an advantageous division into four process modules, whereby both module variant 1a can be combined with the following modules and module variant 1b with the following modules in order to create transistors with different electrical properties on a semiconductor chip.

The modules—module 1a, module 1b, module 2, module 3, and module 4—each have several process steps P11 to P13, P21 to P24, P31 to P37, or P41 to P46 of the manufacturing process, which are identical for the different module variants. Variants of the modules can be produced, for example, by appropriate masking and thereby by a lateral offset s on the same wafer. The first module (module 1a, module 1b) and the second module 2, according to the embodiment of FIG. 1, follow one another after the time t.

Modules 3 and 4 follow module 2 in time. However, modules 3 and 4 do not follow one another in time. In fact, the process steps are in the sequence P31, P32, P33, P41, P42, P43, P34, P35, P36, P37, P44, P45, P46, but the process steps P41, P42, and P43 of module 4 are arranged in time between the process steps P33 and P34 of module 3. Furthermore, process steps P34 to P37 of module 3 are placed in time between process steps P43 and P44 of module 4. Therefore, modules 3 and 4 do not follow one another strictly in time, but the process steps are interlaced in time.

In the following text, it is assumed by way of example that in FIG. 1 the base region is formed in module 3 and the emitter region in module 4. The process interface I₃₄ is placed between base module module 3 and emitter module module 4 in a sequence of the process steps after application of a silicon-germanium semiconductor layer (30, 30′, see FIG. 2) of the base module module 3 and, moreover, before the application of a silicon layer (50, 50′, see FIG. 2) of the base module module 3. Advantageously, the process interface I₃₄ thereby has parameters for two different points in time within the sequence of the process. The first point in time is placed after the process of the application of the silicon-germanium semiconductor layer (30, 30′). The second point in time is placed before the start of the process of the application of the silicon layer (50, 50′) of the base module, module 3.

The modules—module 1a, module 1b, module 2, module 3, and module 4—are defined relative to each other by process interfaces I₁₂, I₂₃, and I₃₄. In the embodiment of FIG. 1, the process interfaces I₁₂, I₂₃ are arranged in time between the first module, module 1a, module 1b, and the second module module 2 and between the second module module 2 and the third module module 3. Based on the described interlacing in time of modules 3 and 4, the defined process interface I₃₄ is critical for three points in time (in FIG. 1, the times for process interface I₃₄ are not indicated). Moreover, an interface, not shown in FIG. 1, between the first module, module 1a, module 1b, and module 3 or module 4 is also possible.

The invention is thereby not limited to the exemplary embodiment depicted in FIG. 1. Thus, additional modules and interfaces can be added, combined, or omitted.

For example, module 1 is a buried connecting region to the electrical contact of a collector semiconductor region or an emitter semiconductor region of the heterobipolar transistor. Module variant 1a, in comparison with module variant 1b, has a lower dopant concentration or a different dopant, so that the thermal budget, defined in the subsequent modules 2 and 3, leads to different out-diffusion of the dopant introduced into module 1 into overlying semiconductor layers during modules 2 and 3. If this semiconductor layer is, for example, an active collector semiconductor layer, both module variants 1a and 1b accordingly produce different collector drift zones for heterobipolar transistors with different high-frequency properties.

If proceeding from process steps P11 to P46 assigned to the modules, a new technology generation with new heterobipolar transistors with, for example, a higher base doping is desired, in this case only process steps P31 to P33 of module 3 are changed. The other process steps, P11 to P24 and P41 to P46, remain unchanged. The options for changing process steps P31 to P33 of module 3 are thereby limited by the interfaces I₂₃ and I₃₄. In other words, the interface-defined boundary conditions for process steps P31 to P33 remain unchanged.

For example, module 1 according to process interface I₁₂ due to the following module 2 requires a certain thermal budget. If process steps P21 to P24 for the new technology version in new process steps (P21′ to P24′, not shown in FIG. 1) are changed, the adherence to the thermal budget has to be considered. If the thermal budget, for example, is too low, a thermal replacement process can be added, which is used exclusively to maintain the process interface condition.

In FIG. 2, a few of the processes of module 3 and module 4 are shown, which define the structural conditions of a process interface I₃₄. This therefore adds the boundary condition, so that for process steps of modules 3 and 4 the geometric layer structure shown schematically in FIG. 2 can be produced.

A detail of a sectional view through a partially processed wafer is shown in FIG. 2. The detail shows a collector region 10, which is isolated laterally by two dielectric regions 20. The connection of collector region 10, for example, via a buried connecting region is not shown in FIG. 2.

In regard to the wafer surface, a semiconductor layer 30, 30′ of a silicon-germanium mixed crystal is applied above the collector region 10 and the isolator region 20, whereby a region 30 above the single-crystal lattice structure of collector region 10 is also formed as a single crystal, whereas another region 30′ of the silicon-germanium semiconductor layer above dielectric 20 is made polycrystalline.

A first silicon layer with a single-crystal region 40, 40′ and a polycrystalline region 40″ is applied above the silicon-germanium semiconductor layer 30, 30′. The first silicon layer thereby preferably has a thickness of less than 70 nm. In the embodiment, shown in FIG. 2, the first silicon layer (40, 40′, 40″) is made initially n-conducting with a significantly lower dopant concentration than the p-conducting doped silicon-germanium layer (30, 30′). Moreover, the collector region 10 is doped n-conducting to form an npn bipolar transistor. In this case, regions 30 and 40 are active regions of the npn bipolar transistor.

In the area of the later emitter region, which is not shown in FIG. 2, a masking of an oxide layer 60 and a nitride layer 70 is then applied, which partially covers the first silicon layer in the single-crystal area. Next, a second silicon layer (50, 50′) is applied, which is doped in situ. In the embodiment of FIG. 2, this layer (50, 50′) is doped p-conducting in situ with a high dopant concentration. In this regard, in situ is understood to mean that during the application of the layer (50, 50′), for example, by a CVD process, the dopant is concurrently introduced into the layer structure. The second silicon layer also forms a single-crystal region 50 and a polycrystalline region 50′. In this regard, the process conditions for the deposition are selected in such a way that the layer 50, 50′ is selectively deposited only over exposed silicon regions 40′ and 40″.

With deposition of the highly doped second silicon layer, this forms a single-crystal region 50 above collector structure 10 and a polycrystalline region 50′ above dielectric 20. Even during the deposition or in a subsequent separate tempering step, a portion of the dopant of the second silicon layer 50, 50′ diffuses into single-crystal region 40′ and also into polycrystalline region 40″ of the first silicon layer adjacent underneath (40′, 40″).

As a result, the first silicon layer is redoped in region 40′, 40″ outside the masking 60, 70 to achieve as low-ohmic a base connection as possible via the extrinsic base, also called the conductive base. The temperature-time budget causing the diffusion is thereby selected in such a way that only a small portion of the dopant below the masking 60, 70 diffuses, so that this region 40 does not become highly p-doped. Moreover, the action of the parasitic conductive base-emitter diode is significantly reduced by the lower layer thickness of the first silicon layer (40).

It is possible to use the described modularity also in a lateral bipolar transistor, but preferably the heterobipolar transistor, as shown in FIG. 2, is vertically integrated, so that the pn junctions form substantially parallel to the wafer surface.

By means of the described exemplary embodiment, it is possible for a silicon-germanium heterobipolar transistor to influence the conductive base thickness, which is influenced by region 50, 50′, separately from the emitter thickness, which is determined significantly by the layer thickness of the first silicon layer in emitter region 40. By this means, the process steps to produce the emitter region and the conductive base can be assigned clearly to the modules (module 3 and module 4) for emitter and/or base, so that a definition of a process interface can occur between these technology modules.

The embodiment shown in the figures enables the realization of bipolar transistors with an emitter strip width less than 0.5 μm. The current through the parasitic conducting base-emitter diode is moreover significantly reduced. Furthermore, the emitter and the base path resistance can be optimized separately from one another.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for manufacturing integrated circuits having silicon-germanium heterobipolar transistors, the method comprising the steps of:
dividing the manufacturing process into a plurality of process modules, the process modules including at least one collector module for the production of a collector region, at least one base module for the production of a base region, and at least one emitter module for the production of an emitter region, the process modules having process interfaces relative to each other; and
changing at least one process step of a process module independently of the process steps of the other process modules while maintaining the process interface to develop a technology version different from an existing technology version

2. The method according to claim 1, wherein one or more process steps of the base module are changed to determine an extrinsic base thickness and/or an extrinsic base dopant concentration in an area of the extrinsic base region independent of one or more process steps of the emitter module, which determine an emitter thickness and/or an emitter dopant concentration in an active region of the emitter region.

3. The method according to claim 1, wherein one or more process steps of the base module, which determine an intrinsic base thickness and/or an intrinsic base dopant concentration in an area of the intrinsic base region independently of one or more process steps of the emitter module, which determine an emitter thickness and/or an emitter dopant concentration in an active region of the emitter region, are changed to develop the different technology version.

4. The method according to claim 1, wherein one of the process interfaces is provided between the base module and the emitter module in a sequence of process steps after application of a silicon-germanium semiconductor layer of the base module and before the application of a silicon layer, which is suitable for low-ohmic connection of the silicon-germanium semiconductor layer.

5. The method according to claim 4, wherein the silicon layer is deposited selectively on the dielectric regions, at least above the silicon-germanium semiconductor layer.

6. The method according to claim 1, wherein one or more process steps of the emitter module occur in time between at least two process steps of the base module or one or more process steps of the base module occur in time between at least two process steps of the emitter module.

7. The method according to claim 1, wherein, to develop a new technology generation that is different from the existing technology generation, at least one process interface condition of at least one of the process interfaces is changed or at most three process interface conditions of the process interfaces are changed.

8. The method according to claim 7, wherein the process interface condition is a thickness range of an additional silicon layer applied in the emitter module between a minimal layer thickness and a maximum layer thickness, wherein an area of the additional silicon layer is redoped by process steps of the base module to form a low-ohmic connection of a silicon-germanium semiconductor layer previously applied in the base module.

9. The method according to claim 7, wherein at least one of the process interfaces has at least one process interface condition, which is dependent on at least two process parameters variable within specified regions.

10. The method according to claim 1, wherein at least one process module has at least two module variants.

11. The method according to claim 1, wherein at least two module variants are performed on the same integrated circuit.

12. The method according to claim 1, wherein, within the base module, a semiconductor layer is selectively applied, which is doped in situ with dopants of a conductivity type of the base region.

13. The method according to claim 12, wherein at least one single-crystal region and one polycrystalline region of the semiconductor layer are formed.

14. The method according to claim 1, wherein a high-frequency circuit with at least one high-frequency bipolar transistor is manufactured.

15. The method according to claim 1, wherein the method adapts the technology version to an application-specific boundary condition.
